(19) United States
(12) Patent Application Publication
(10) Pub. No.: US 2005/0254342 A1
(43) Pub. Date: Nov. 17, 2005

(54) Shaking device and method, particularly for dispersing or emulsifying two immiscible fluids

(76) Inventors: Daniel Cuzin, Mareil-Marly (FR); Marc Baroni, Paris (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/501,220

(22) PCT Filed: Jan. 10, 2003
(86) PCT No.: PCT/FR03/00073

§ 371 Date: Jul. 12, 2004

(30) Foreign Application Priority Data
Jan. 11, 2002 (FR) 02/00306

(51) Int. Cl. B01F 7/26

(52) U.S. Cl. 366/315

(57) ABSTRACT

The invention relates to a rotating shaking device comprising a mixing element operating according to the principle of a static mixer. The inventive mixing element is radially fixed on a hollow axle (1, 2) and has a cavity filled by a lining. Said cavity communicates with the interior space of the hollow axle and the fluid medium to be shaken. The invention also relates to a shaking method for which said device is used.

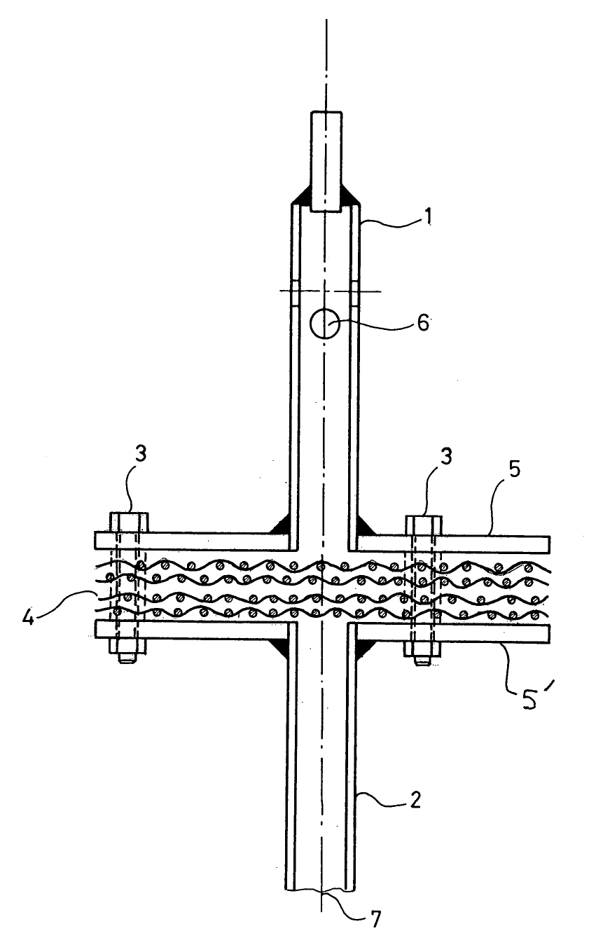

The invention relates to a stirring device and method, in particular used for the dispersion or emulsion of two immiscible liquids.

Rotating stirrers are known comprising one or more mobile elements fixed to a shaft. The shear, turbulence and circulation which the stirrer introduces into the liquid to be mixed then depend in particular on the characteristics of the mobile element, in particular on its geometry.

For the dispersion or emulsification of immiscible liquids, it is important for the stirrer to impart a strong shear.

Examples of such stirrers are rotor and stator mixers. Devices of this kind are marketed by Rayneri under the Ultramix trademark and by IKA under the Ultra Turrax trademark. The rotor, for example a turbine, is mounted inside a fixed part, the stator. The relative displacement of the rotor with respect to the stator then engenders shear forces which cause the dispersion or emulsification of the liquids.

From the document “Development of self-inducing disperser for gas/liquid and liquid/liquid systems”, Second European Conference on Mixing, 30 Mar.-1 Apr. 1977, a mixing technique is also known, based on the shear induced by centrifugal force to which the fluid is subjected, linked with the Venturi effect resulting from the particular design of the mobile stirring element.

Moreover, static mixers are also known in which the liquid flow successively crosses a series of fixed mixing elements which deflect and divide the flow. The effectiveness of the apparatus is linked to the geometry of the mixing elements and to their number.

However, the two types of devices have drawbacks.

In fact, in order to respond to the necessity to create a high shear within the liquid, rotor and stator stirrers are complex mechanical devices due to the small dimension of the gap which means severe constraints on the machining and alignment tolerances, the geometry of the small perforations in the stator and the high speed of the rotor. Moreover, the considerable dissipation of energy in a small volume leads to heating which can have an influence on the fluids to be mixed, or even lead to safety problems.

The static mixer requires the circulation of the liquid to be mixed. Thus, most often, it will be necessary to resort to a pump. These devices are moreover not very suitable for the preparation of dispersions or emulsions of immiscible liquids. British patent No. 237,325 describes a device for the mixing, emulsification or atomization of immiscible liquids or gas-liquid mixtures. This device is constituted by two coaxial discs mounted on a shaft, separated by an annular space filled by a packing permeable to the fluids. The fluid to be treated is introduced via a pipe in the centre of the assembly constituted by the discs and the packing. When the device is rotated, centrifugal force expels the fluid through the packing, which plays the same role as a static mixer by dividing the flow of liquid and imparting shear forces to it, which leads to increasingly thorough mixing when the fluid progresses from the centre of the assembly towards its periphery.

U.S. Pat. No. 2,814,527 describes a centrifugal atomizer, the basic operating principle of which is similar to that of the device described in the abovementioned GB patent, the liquid being atomized while circulating under the effect of centrifugal force through a set of baffles arranged according to a particular geometry on the circumference of the atomizer.

The apparatuses described in these British and American patents are well suited to the atomization of liquids or the mixing of liquids in continuous-type methods, but they are not suitable for carrying out the mixing or emulsification of two immiscible liquids in a batch-type (discontinuous) method, where the mobile stirring element is immersed in the liquids to be mixed throughout the operation.

U.S. Pat. No. 6,280,078 describes an apparatus for the mixing and aeration of liquid made up of a concentric stack of rings with the same external diameter and decreasing internal diameter fixed on a common shaft and separated from each other by shims delimiting, between the rings, free spaces allowing the passage of the liquid. The device is immersed in the liquid to be mixed or aerated. When it is rotated, centrifugal force causes the aspiration of the liquid and, if appropriate, of the air above the free surface of the liquid, and their expulsion through free spaces separating the rings.

The apparatus described in this U.S. Pat. No. 6,280,078, which is especially suited to the aeration of liquids, does not contain any particular device intended to cause a thorough mixing of the liquids to be mixed, in the case of the mixing of two immiscible liquids.

A subject of the present invention is to propose a stirring device and method, in particular for the dispersion and emulsification of immiscible liquids, which does not have the drawbacks of the prior art.

An object of the invention is therefore a rotating stirring device comprising a mixing element operating according to the static mixer principle, fixed radially on a hollow shaft, this mixing element containing a cavity filled by a packing and communicating with the interior space of the hollow shaft and the fluid medium to be stirred.

According to a particular embodiment of the invention, the mixing element comprises:
two discs pierced in their centre;
a fixing device making the two discs integral with one another, delimiting a space between them; and
a packing arranged in the space thus delimited,
the hollow shaft being formed by an upper part integral with one of the discs and a lower part integral with the other disc.

In particular, one or more openings made in the upper and lower part of the hollow shaft allow the fluids to be mixed to circulate in the shaft and in the packing.

According to one embodiment, the fixing between the first and second disc is achieved by one or more spacers.

Preferably, the opening in the lower part of the hollow shaft is constituted by its end.

Advantageously, the opening in the upper part of the hollow shaft is constituted by an opening made in the side of the hollow shaft.

According to another embodiment, one or more pipes are fixed radially on the hollow shaft. They communicate with the interior space of the shaft and are filled with packing similar to the types of packings used in the static mixers of the prior art.

The packing is advantageously constituted by a set of solid elements made of suitable material, i.e. in particular of material which is inert vis-à-vis the fluids to be mixed. The solid elements can be for example made of metal, plastic, ceramic material or glass. They can be disposed according to a regular or irregular arrangement inside the cavity constituting the free space of the mixing element. The packing will be advantageously fixed in the cavity in such a manner as to prevent its displacement or loss under the movement of the fluids to be mixed.

The packing can in particular be composed of one or more layers of mesh. This mesh is advantageously of metal.

It can for example comprise two “layers” separated by a space forming a mixing zone, optionally equipped with a perforated plate optionally corrugated at its periphery or a grating having a larger mesh opening.

Another subject of the invention is a method for the preparation of a dispersion or emulsion of immiscible liquids by means of a rotating stirring device comprising a mixing element operating according to the static mixer principle, fixed radially to a hollow shaft, this mixing element containing a cavity filled by a packing, said cavity communicating on the one hand with the interior space of the hollow shaft, and on the other hand with the liquid medium to be stirred, in which the stirrer is rotated, the liquids to be mixed are aspirated through hollow shafts under the effect of centrifugal force, and mix thoroughly while passing through the packing before being expelled at the periphery of the packing.

Another subject of the invention is the use of the device according to the invention for the preparation of dispersions and/or emulsions of immiscible liquids.

The device according to the invention is explained in more detail with reference to the single attached FIGURE which shows an embodiment of a stirrer according to the invention.

The device according to the embodiment illustrated in the single FIGURE comprises the following elements:
a first upper part comprising a first disc 5 fixed by any known mechanical means (for example welding, screwing) to the lower end of a hollow shaft 1. The hollow shaft 1 is pierced close to its upper end by a lateral orifice 6 allowing the circulation of the liquid in which the device is immersed;
a lower part similar to the upper part, comprising a second disc 5′ fixed by any mechanical means to the upper end of a hollow shaft 2. The lower end of the hollow shaft 2 is open and allows free passage to the liquid in which the device is immersed.

The two discs 5, 5′ are made integral with one another, while making a space between them by any suitable means. Preferably this means is constituted by several spacers situated on the periphery of the discs and regularly distributed, e.g. 120° from one another, and making a cylindrical space between the discs. The number of spacers linking the two discs will preferably be proportional to the size of the device. In the case of use of a single spacer, attention will be paid to equilibrium, in order to ensure a good rotation of the assembly.

The space made between the discs 5, 5′ is filled by a packing forming baffles. Such a packing is preferably made up of a stack of several layers of metal gratings cut out in the form of discs of the same diameter as the discs 5, 5′.

At the free upper end of the hollow shaft 1 of the upper part of the device there is fixed by any suitable mechanical means (for example welding, screwing) a solid shaft making it possible to couple the device, either directly or via a speed reducer, to a motor capable of imparting a rotational movement to it.

Preferably, the hollow shaft 1 and the disc 5 on the one hand, the hollow shaft 2 and the disc 5′ on the other hand each form an assembly, the shaft and the disc being made integral with one another by any suitable means (welding, screwing etc.).

However, the discs 5, 5′ can in principle be replaced by other elements considered as equivalent as soon as they define a mixing space containing the packings, linked to the two hollow shafts and allowing a radial extraction of the resultant mixture. These elements are such that they allow a good rotation of the assembly. By way of example, there can be mentioned the use of several hollow blades or several pipes, communicating with the shaft and each equipped individually with elements of a packing similar to those used in static mixers.

Blades (e.g. of the type of those in a Rushton mixer) could moreover be provided on the disc(s) (5, 5′) in order to obtain, at the start, a coarse mixture which is then refined by the stirrer according to the invention.

The operation of the stirrer according to the invention is the following:

The liquids to be mixed are introduced into a suitable tank in which the stirrer is arranged. Preferably, the interface between the two liquids is situated at the level of the packing, i.e. each shaft is immersed in a separate liquid. When the stirrer is rotated, the liquids are aspirated through hollow shafts under the effect of centrifugal force and mix thoroughly while passing through the packing forming baffles before being expelled at its periphery.

In this manner, the rotation of the stirrer allows the packing to play the role of a static mixer, thus reinforcing the mixing effect obtained.

In fact, the device according to the invention allows the preparation of an emulsion of two liquids at a much lower speed than the known rotor-stator stirrers.

Thus, a stirring device according to the embodiment indicated in the FIGURE was used to disperse a mixture of water and standard multigrade motor oil. A stable emulsion was obtained in less than 5 minutes with a rotational speed of only 60 rpm for a diameter of the discs of 11 cm.

The method according to the invention consists of using the device according to the invention to produce a dispersion or emulsion of immiscible liquids.

This method can be continuous or discontinuous.

The method and the device according to the invention therefore allow production of a mixture in a simple, flexible, rapid and inexpensive manner, which is effective at a low rotational speed, and particularly suited to the dispersion or emulsification of immiscible liquids.

Thus, the invention allows mixing of liquid constituents that are not very compatible before reaction or polymerization. Given that no vortex is produced, the invention makes it possible to work with reduced quantities of surfactants and to avoid the formation of foam.

As particularly interesting uses of the device and method according to the invention, there can be mentioned the preparation of dispersions of incompatible liquids intended for reactions (polymerization etc.) of dispersions of latex with charges (these dispersions can then be produced without using antifoaming agent), or emulsions intended for emulsion polymerizations.

The stirrer according to the invention promotes liquid/liquid transfers by increasing the specific surface area, promotes the rapid dispersion of liquids or solids in a liquid without shearing, therefore without heating.

### EXAMPLES

The following examples illustrate the present invention without however limiting its scope.

### Example 1

In this example, a Rushton turbine, a rotor and stator mixer from the abovementioned company IKA and a device according to the invention have been compared.

The transparent test tank had a diameter of 28 cm, was equipped with four counter-blades on its periphery arranged symmetrically and contained approximately 20 litres of liquids.

The Rushton turbine (diameter 10 cm) and the device according to the invention (diameter 11 cm) were introduced (in three parallel tests) into the test tank containing 50% oil and 50% water (% by volume) and rotated by means of a variable-speed stirring motor.

The evolution of the viscosity of the contents of the tank is monitored by means of a Brookfields viscometer (module 2, speed 20).

With the Rushton turbine (6 blades) rotating at 300 rpm and 500 rpm, the interface between the oil and the water disappears instantly but the solution is unstable and the sample taken partially settles before the viscosity measurement is made. The viscosity is not measurable with the Brookfields with module 2 (speed 20). A vortex forms.

With the IKA mixer, of the rotor-stator and pump type (rotational speed of the rotor 3000 rpm, flow rate 1 l/s) placed in a by-pass loop on a reactor containing 30 litres of “water-oil” mixture, direct emulsification of the “water-oil” mixture is attempted, but the emulsion does not stabilize and it is not possible to directly obtain a homogeneous product and a sample representative of the whole solution. The rotor-stator system does not have the power to mix the liquids and does not produce a homogeneous product after 6 passes. A premixing (with the device according to the invention) is necessary if the IKA mixer is to provide an emulsion (of a quality more or less identical to that obtained with the device according to the invention).

With the device according to the invention, it is noted that the interface between the oil and the water disappears very rapidly, the viscosity evolves rapidly and stabilizes at 560 cps at 300 rpm, and at 620 cps at 500 rpm. The solution is milky-white in colour and it is still possible to distinguish with the naked eye a few drops of oil the size of which is of the order of 0.5 mm and which have not been dispersed. No vortex is produced and the surface of the stirred medium remains flat.

The device according to the invention allows pumping and rapidly provides a very homogeneous treated solution, without causing a vortex. Unlike the IKA mixer, the device according to the invention does not need a loop. It is therefore much more flexible than the IKA mixer.

### Example 2

In this example, the time necessary for the settling of the mixtures emulsified in Example 1 with a device according to the invention, i.e. the time necessary for the two phases to return to their initial state, was compared.

This time depends on the stirring speed:
2 h 30 min for 300 rpm
5 h for 500 rpm.

With the rushton turbine, after stirring at 300 rpm, the return to the initial state requires only 30 minutes, which means that the emulsion was relatively unstable.

1. Rotating stirring device comprising a mixing element operating according to the static mixer principle, fixed radially on a hollow shaft (1, 2), this mixing element containing a cavity filled by a packing, said cavity communicating on the one hand with the interior space of the hollow shaft, on the other hand with the fluid medium to be stirred.

2. Device according to claim 1, in which the mixing element comprises:
two discs (5, 5′) pierced in their centre;
a fixing device (3) making the two discs (5, 5′) integral with one another, delimiting a space between them; and
a packing (4) arranged in the space thus delimited,
the hollow shaft being formed by an upper part (1) integral with the disc (5) and a lower part (2) integral with the disc (5′).

3. Device according to claim 2, in which the hollow shaft (1, 2) contains an opening (6) in its upper part and an opening (7) in its lower part.

4. Device according to claim 1, in which the fixing between the first and second disc (5, 5′) is achieved by one or more spacers.

5. Device according to claim 1, in which the opening (7) in the hollow shaft (2) is constituted by its end.

6. Device according to claim 1, in which the opening (6) in the hollow shaft (1) is made in the side of the shaft.

7. Device according to claim 1, in which there are fixed radially on the hollow shaft (1, 2) one or more pipe(s) communicating with the interior space of the shaft and filled with packing.

8. Device according to claim 1, in which the packing (4) is composed of an assembly of solid elements made from metal, plastic, ceramic, glass material, disposed according to a regular or irregular arrangement.

9. Device according to claim 8, in which the packing (4) is made up of one or more layers of mesh.

10. Device according to claim 9, in which the mesh is of metal.

11. Use of the device according to claim 1 for the preparation of dispersions and/or emulsions of immiscible liquids.

12. Method for preparing a dispersion or emulsion of immiscible liquids by means of a rotating stirring device comprising a mixing element operating according to the static mixer principle, fixed radially to a hollow shaft (1, 2), this mixing element containing a cavity filled by a packing (4), said cavity communicating on the one hand with the interior space of the hollow shaft, on the other hand with the fluid medium to be stirred, in which the stirrer is rotated, the liquids to be mixed are aspirated through the hollow shaft under the effect of the centrifugal force, and mix thoroughly while passing through the packing before being expelled at the periphery of the packing (4).

13. Method according to claim 12, in which one of the liquids enters by the upper part (1) and the other by the lower part (2) of the hollow shaft.

14. Method according to claim 12, in which the rotating stirring device is a mixing element comprising:
two discs (5, 5′) pierced in their centre.
a fixing device (3) making the two discs (5, 5′) integral with one another, delimiting a space between them; and
a packing (4) arranged in the space thus delimited,
the hollow shaft being formed by an upper part (1) integral with the disc (5) and a lower part (2) integral with the disc (5′).

15. Method according to claim 12, in which the interface between the two liquids is situated at the level of the packing (4).
